(19) United States
(12) Patent Application Publication
(10) Pub. No.: US 2007/0147388 A1
(43) Pub. Date: Jun. 28, 2007

(54) Terminal and method for setting quality of service therein

(75) Inventors: Jun-Sik Kim, Seongnam-city (KR); Nam-Hoon Park, Daejeon-city (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); Electronics and Telecommunications Research Institute, Daejeon (KR); KT Corporation, Seongnam-city (KR); SK TELECOM CO., LTD, Seoul (KR); HANARO TELECOM., INC., Seoul (KR)

(21) Appl. No.: 11/635,421

(22) Filed: Dec. 7, 2006

(30) Foreign Application Priority Data
Dec. 7, 2005 (KR) 2005-118747

(51) Int. Cl. H04L 12/56; H04L 12/28

(52) U.S. Cl. 370/395.21; 370/235

(57) ABSTRACT

The present invention provides a method for setting a quality of service (QoS) in a terminal. The method includes receiving from a base station and displaying information regarding radio resource usage condition in a communication network; receiving and setting a QoS demanded by a user; receiving a data service by using the established QoS; checking the information regarding radio resource usage condition, wherein the radio resource is regularly provided, and changing or resetting QoS.

### PRIORITY

This application claims priority to and the benefit of Korean Patent Application No. 10-2005-0118747 filed in the Korean Intellectual Property Office on Dec. 7, 2005, the entire content of which is incorporated herein by reference.

### BACKGROUND OF THE INVENTION

1. Field of the Invention

The present invention relates to a terminal and a method for setting a Quality of Service (QoS) therein. More particularly, when a terminal is connected to a communication network, the present invention relates to a terminal and a method for setting QoS therein in order to supply users with high-quality wireless communication environment.

2. Description of the Related Art

Current wireless access techniques include a physical layer technique and a protocol layer technique. The wireless access technique is the most important technique for the communication system providing multimedia services through high-rate data transmission.

The physical layer technique includes modulation/demodulation, spread/dispread, channel coding and various diversity methods, and the physical layer technique for high-rate data transmission has been considerably improved by the extensive research being conducted thereon. However, the protocol layer technique, which includes a radio resource management (RRM), has not been improved relative to the physical layer technique.

Packet data transmission for providing multimedia service and internet service is a main consideration for current communication systems, wherein call admission control (CAC), congestion control (CC), dynamic channel allocation (DCA), hand-off, power control (PC), data rate control (RC), packet scheduling, hybrid scheduling in the system simultaneously including wires and packets, and automatic repeat request (ARQ) perform critical functions in order to efficiently use radio resource for traffic transmission requiring assurance of various communication QoS.

Since the Internet service is provided through the communication network, user demand for packet data service is significantly increased. The communication system performing transmission functions only for a small amount of data, such as voice calling service and short message service (SMS), is currently providing various packet data service according to such user demands because the conventional communication system is improved to the communication system, such as IMT-200 having wide bandwidth.

FIG. 1 is a diagram showing a communication network. Several terminals 110 are included in one single cell 115 controlled by one base station 120 in the communication network, and the terminals 110 are connected to the wireless network or wired network through the base station 120. When the terminals 110 are simultaneously served, the base station 120 needs to set a QoS in order to properly allocate and control the radio resource according to a user demand and an application program.

A conventional communication system is hard to actively respond to different service demands according to subscriber demands, and it has a lot of constraint conditions in using the radio resource.

However, the next generation communication system, such as IMT-2000, has a goal to provide various multimedia services including high-speed portable Internet (HPI), and the multimedia traffic applied to the base station by input load has more complicated and variously changing characteristics compared to the voice traffic used for the conventional voice call service.

The multimedia traffic using the radio resources for providing the multimedia services needs to maintain resources guaranteeing transmission speed that is required for appropriately providing the multimedia service. Therefore, the communication system charges fees for using the radio resources upon users according to the QoS used for providing the multimedia services, and the users are provided with the multimedia services according to the fees for QoS established by the communication system.

Consequently, since the users select the QoS according to the significance of service, methods for efficiently controlling cost and QoS are required for providing the multimedia services.

Since a conventional method for controlling QoS controls the radio resources according to service requests by the terminals in the communication system or controls only rejection rates for packet services, users cannot actually select and control QoS by themselves.

The above information disclosed in this Background section is only for enhancement of understanding of the background of the invention and therefore it may contain information that does not form the prior art that is already known to a person of ordinary skill in the art.

### SUMMARY OF THE INVENTION

The present invention has been made in an effort to provide a terminal and a method for setting quality of service (QoS) having advantages of setting QoS by identifying a server IP or performing an application program when radio resource usage condition that is received from the communication system through a terminal is checked and QoS demanded by a user is requested.

A method for setting QoS in a terminal according to the present invention may include receiving from a base station first information regarding a radio resource usage condition in a communication network; setting a current QoS according to the radio resource usage condition of the first information; setting a path for a data service between the base station and the terminal; receiving the data service by using the current QoS; and checking second information regarding the radio resource usage condition that is regularly provided by the base station; and receiving the data service by resetting the current QoS according to the radio resource usage condition of the second information.

According to the present invention, a terminal that selects quality of data service by checking a radio resource usage condition in a communication network may include data storage unit for storing a service grade profile including information regarding a QoS set according to the radio resource usage condition; a program memory for storing a program for controlling the terminal, an application program for the data service, a QoS setting program, and a program for checking the radio resource usage condition; a user interface for providing the terminal user with the radio resource usage condition from the communication network or receiving requests for the QoS setting and QoS change from the terminal user; and a controller for receiving the radio resource usage condition from the communication network to display the radio resource usage condition through the user interface, and controlling QoS setting operations by executing instruction for setting QoS by using the QoS setting program.

A recoding medium of a terminal, wherein the recording medium records a program for realizing a method that includes receiving from a base station first information regarding a radio resource usage condition in a communication network; setting QoS according to the first information; and receiving data service from the base station by using the QoS.

### BRIEF DESCRIPTION OF THE DRAWINGS

FIG. 1 is a diagram showing a communication network.

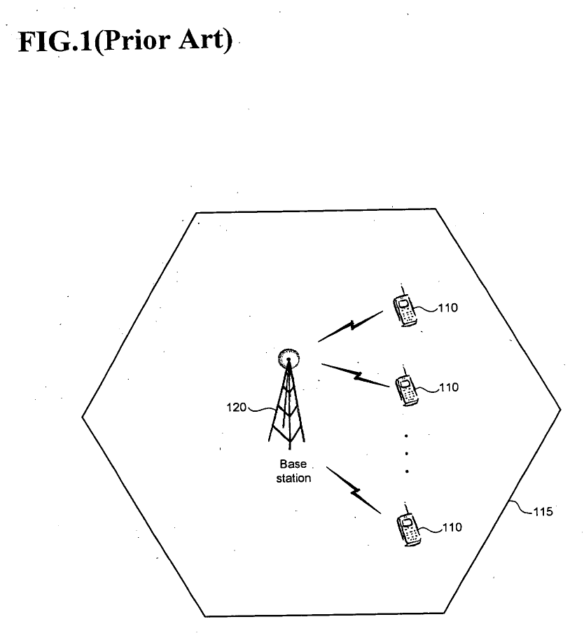

FIG. 2 is a diagram showing radio resource allocation according to an exemplary embodiment of the present invention.

FIG. 3 is a block diagram showing an algorithm that determines data significance in a terminal and allocates radio resources according to the exemplary embodiment of the present invention.

FIG. 4 is a fee schedule charging table by usage of radio resources and QoS according to the exemplary embodiment of the present invention.

FIG. 5 is an example of a profile table for a service grade established by the exemplary embodiment of the present invention.

FIG. 6 is a flow chart showing a method for allocating radio resources in a base station according to the exemplary embodiment of the present invention.

FIG. 7 is a flow chart showing a method for setting QoS in a terminal according to the exemplary embodiment of the present invention.

FIG. 8 is a diagram showing an inside of a terminal wherein QoS setting is performed according to the exemplary embodiment of the present invention.

### DETAILED DESCRIPTION OF THE PREFERRED EMBODIMENTS

Preferred embodiments of the present invention will hereinafter be described in detail with reference to the accompanying drawings.

In the following detailed description, only certain preferred embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

The word “block” described in this specification or shown in the drawings denotes at least one single unit performing specific function or operation, and the block can be embodied by a hardware or software or combination of hardware and software.

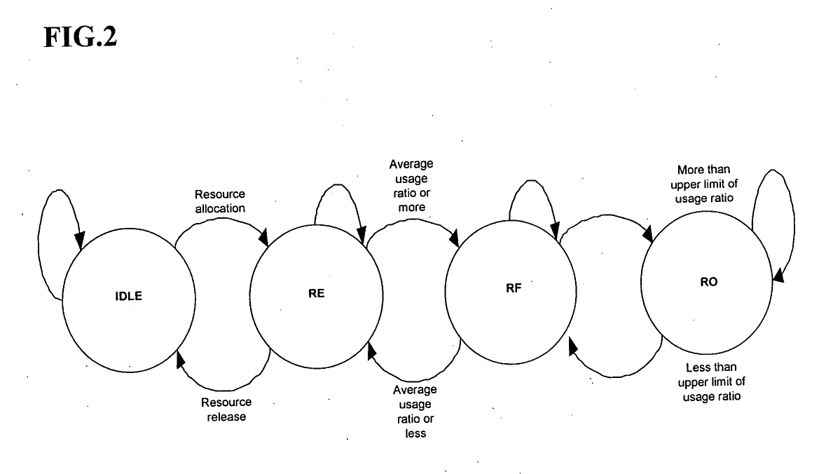

FIG. 2 is a diagram showing radio resource allocation according to an exemplary embodiment of the present invention.

As shown in FIG. 2, a control layer for radio resource in a communication system classifies usage conditions for the radio resources into a plurality of conditions. The plurality of conditions includes four conditions, such as idle (IDLE) condition, resource enough (RE) condition, resource full (RF) condition, and resource overload (RO) condition. In addition, transition between four conditions may occur according to radio resource usage.

A base station starts allocating radio resources in the initial IDLE condition. When the radio resources are allocated, the radio resource usage condition transits to the RE condition, and then the radio resources are allocated without any limit according to user demands. The radio resource usage is regularly checked, and when the radio resource usage exceeds the average usage of the radio resource allocation unit, the radio resource usage condition transits to the RF condition. When the radio resource usage in the RF condition exceeds predetermined upper limit of usage, the radio resource usage condition transits to the RO condition, and when the radio resource usage drops below the average usage, the radio resource usage condition transits to the RE condition.

In addition, when the radio resource usage in the RO condition drops less than the predetermined upper limit of usage, the radio resource usage condition transits to the RF condition.

Such radio resource usage conditions established in the base station are regularly transmitted to the terminals so as to provide bases for establishing parameter for wireless and various resources allocation.

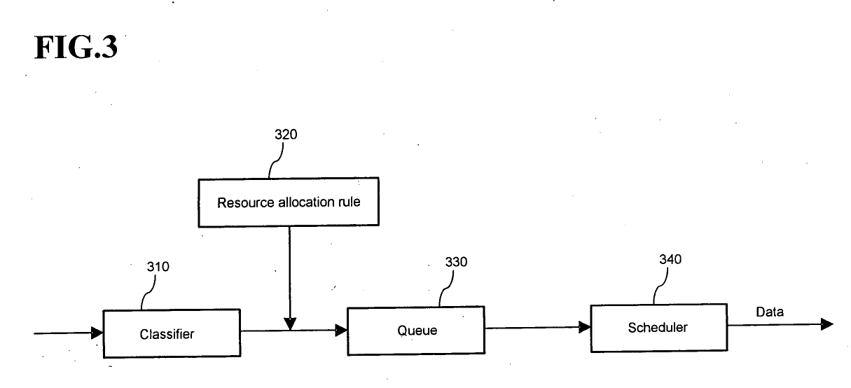

FIG. 3 is a block diagram showing an algorithm that determines data significance in a terminal and allocates radio resources according the exemplary embodiment of the present invention.

The algorithm for allocating the radio resources according to the exemplary embodiment of the present invention includes a classifier 310, resource allocation rule 320, queue 330, and scheduler 340.

The classifier 310 input by transmission data determines data significance, and classifies data according to the data significance. The classifier 310 classifies data by using the resource allocation rule 320 storing data classification standards.

Subsequently, data classified by the resource allocation rule 320 and classifier 310 are input to the queue 330 so as to remain for the transmission.

When it is determined that transmission data remains in the queue 330, the scheduler 340 checks the radio resource usage condition in the communication network. When residual radio resources remain in the queue 330, the scheduler 340 transmits data stored in the queue 330 after allocating the radio resources to the stored data.

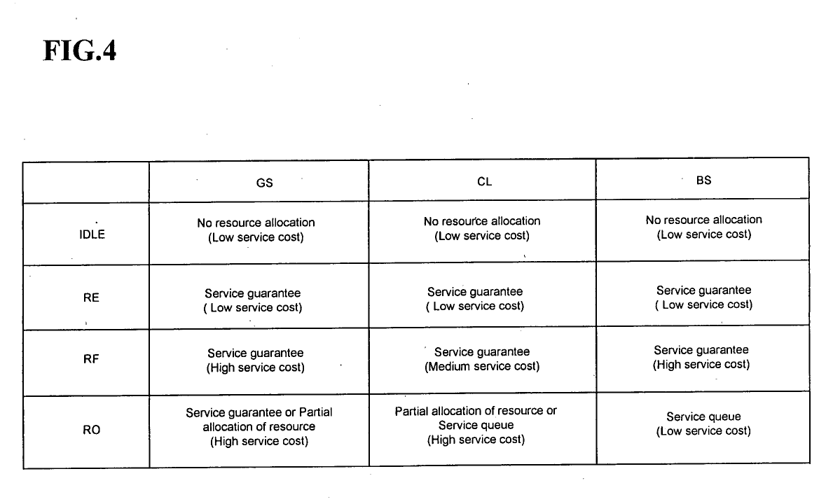

FIG. 4 is a fee schedule charging table by usage of radio resources and QoS according to the exemplary embodiment of the present invention.

The service grades in the fee schedule charging table are classified into three grades, such as guaranteed service (GS) grade for high-priority data transmission, controlled load service (CL) for medium-priority data transmission occupying most data service classification, and best effort service (BS) for low-priority data transmission that is not closely related to the time. The radio resource allocation and various parameters for each service grade are determined according to the current condition for the radio resource allocation.

When the current condition for the radio resource allocation is the IDLE condition, the radio resources are not allocated and the charging conditions are set to be low because there are no user demands for the user service. In addition, when the current condition for the radio resource allocation is the RE condition, the radio resources requested by the users are allocated in all service grades, such as GS, CL, BS, because there are sufficient radio resources. Accordingly, all the charging conditions are set to be low.

However, when the current condition for the radio resource allocation is RF, the radio resources are preferentially allocated to GS and CL service grades, and then the residual radio resources are allocated to BS service grade within the limit wherein the RF condition is remaining. Accordingly, the charging conditions are set to be highest in GS service grade, and middle in CL service grade. In addition, the charging condition is set to be lowest in BS service grade because the BS service grade has relatively low allocation probability.

In the case of the RO condition having the high radio resource usage, the charging condition is set to be high in guaranteeing the radio resources allocated to the GS service grade because the radio resources are not sufficient. However, the service is not provided for the new request by the GS service grade. On other hand, the radio resources are partially allocated to the CL service grade or the service queue condition is established in the CL service grade. In addition, the charging condition is set to be high for the data service in the CL grade. In the case of the BS service grade, the service queue condition is established, and the charging condition is set to be low.

As described above, since the charging conditions are differently set according to the service grade, users need to establish QoS by the types of the data services.

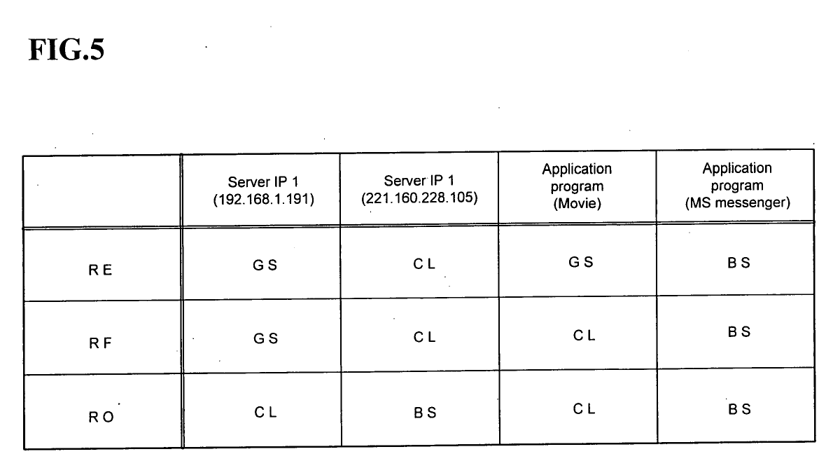

FIG. 5 is an example of a table for a service grade profile established by the exemplary embodiment of the present invention.

Users can manage a service grade profile through a user interface of a terminal. The service grade profile, such as GS, CL, and BS, is previously determined by the users according to each data service.

The types of the data service provided through the communication network need to be checked in order to establish the service grade profile. The types of the data services can be checked by using network address, for example, internet protocol (IP) address of the server providing the data services or by using the application program. In addition, the determination methods by using the IP address of the server and by using the application program are simultaneously applied.

When the service grade profile is predetermined as shown in the table of FIG. 5, and the terminal is supplied with the data service from the server of which its IP address is 192.168.1.191, the data service is provided through the GS service grade in the RE and RF conditions having low radio resources usages, and the data service is provided through the CL service grade in the RO condition. In addition, when the terminal is supplied with the data service from the server of which the IP address is 221.160.228.105, the data service is provided through the CL service grade in the RE and RF conditions, and the data service is provided through the BS service grade in the RO condition.

In addition, when the application program for displaying movies is executed, the data service is provided through the GS service grade in case that the radio resource usage is the RE condition, and the data service is provided through the CL service grade in case that the radio resource usage is the RF and FO conditions. However, when the messenger having low data capacity is executed in the terminal, the data service is provided through the BS service grade regardless of the radio resource usage such as the RE, RF, or RO condition.

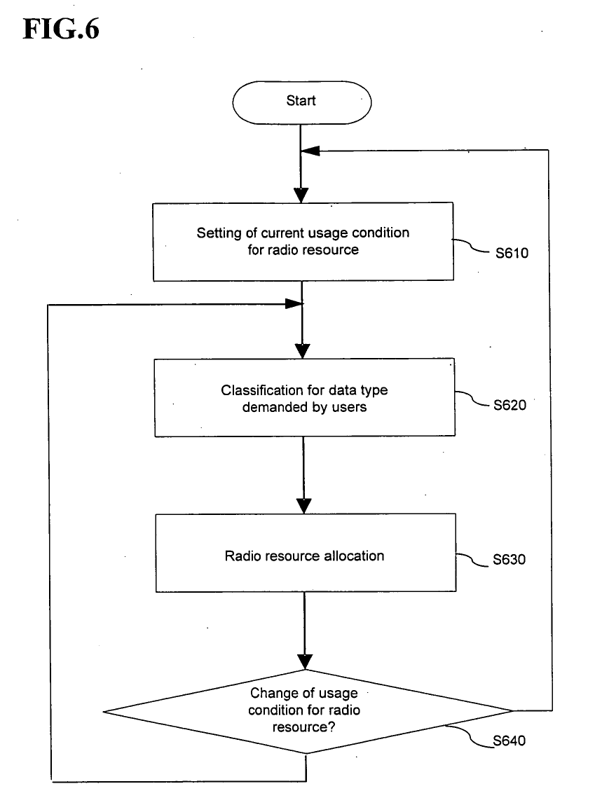

FIG. 6 is a flow chart showing a method for allocating radio resources in the base station according to the exemplary embodiment of the present invention.

As shown in FIG. 6, the base station sets the current condition for the radio resource usage at step S610 when the radio resource usage starts according to the communication service.

When the condition for the radio resource usage is set, the radio resource allocation rule is established in the current condition, and various operation parameters are created.

Subsequently, when the data service is requested by the user of the terminal that is located in the cell region controlled by the base station, the type of the data service requested by the terminal is classified into GS, CL, or BS at step S620, and the radio resource is allocated according to the type of the data service requested by the terminal at step S630.

The base station provides the data service by using the allocated radio resource, and the base station regularly checks the condition of the radio resource usage. The base station transits between the conditions for the radio resource usage, such as the IDLE, RE, RF, and RO conditions. When the transitions between the conditions for the radio resource usage are performed, the rules for the radio resource allocation and the parameter creation are newly established at step S640.

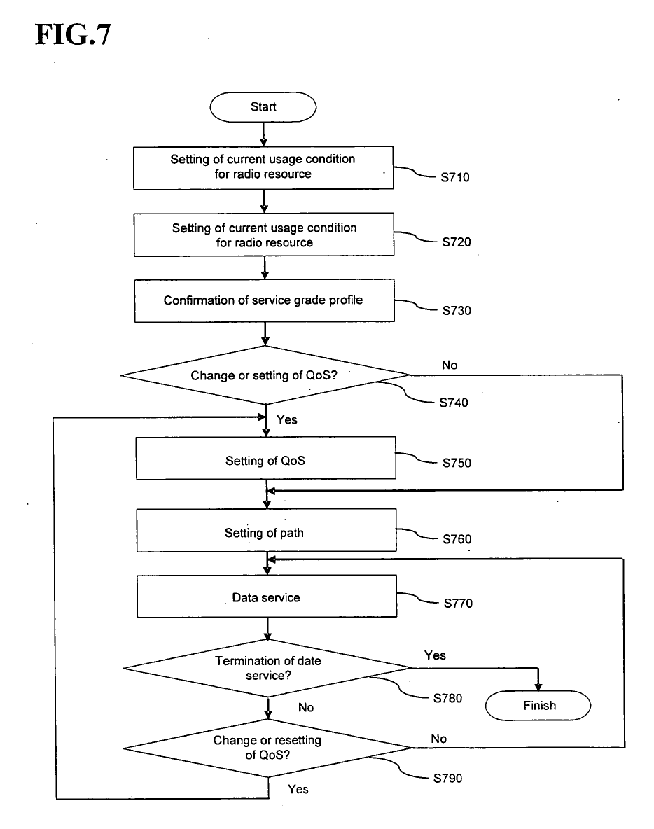

FIG. 7 is a flow chart showing a method for setting QoS in the terminal according to the exemplary embodiment of the present invention.

The terminal is connected to the base station in order to be provided with the data services, wherein the base station controls the cells including the terminal. The base station regularly sets the condition for the radio resource usage at step S710. The base station regularly broadcasts the predetermined condition for the radio resource usage to the terminal in the cell region at step S720.

The terminal receiving the condition for the radio resource usage from the terminal displays the received condition for the radio resource usage through the user interface. The user of the terminal checks the service grade profile that is set before the call access for the data service. At this time, when the predetermined service grade profile does not exist, the QoS condition that is previously established may be maintained. When the QoS condition is predetermined by the service grade profile, the terminal displays the QoS condition in order for the user to check the QoS at step S730.

In addition, the user may not use the QoS established by the service grade profile, and the user may change the QoS according to the condition for the radio resource usage receiving from the base station.

When the application program is executed for the first time or the server is firstly connected for providing the data service, the terminal user may establish the QoS for the corresponding data service because the QoS is not established to the service grade profile. In addition, the user may be provided with the data service by using another QoS rather than the QoS predetermined in the service grade profile.

When the users want to change or establish the QoS for the data services by using the key button of the terminal at step S740, the screen for changing or setting the QoS is displayed to the users in order for the users to select the QoS. Subsequently, the QoS is changed or set according to the user selection at step S750.

When the QoS has been changed or set or when the users use the predetermined QoS in the service grade profile instead of changing the QoS, a path for the data service is set at step S760, and the data service is provided through the communication network at step S770.

The terminal determines the condition for the radio resource usage that is regularly provided by the base station, and the terminal displays information regarding the condition for the radio resource to the users. At this time, the terminal may be set to display the information regarding the condition for the radio resource whenever the terminal regularly receives the information regarding the condition for the radio resource, and the terminal may be set to display the information only when the condition for the radio resource usage transits between the IDLE, RE, RF, and RO conditions, and the terminal may be set to display the information when the user request exists.

The user may change or reset the QoS after checking the displayed information regarding the condition for the radio resource usage. When the QoS is changed or reset, the steps after S750 are performed again (S780).

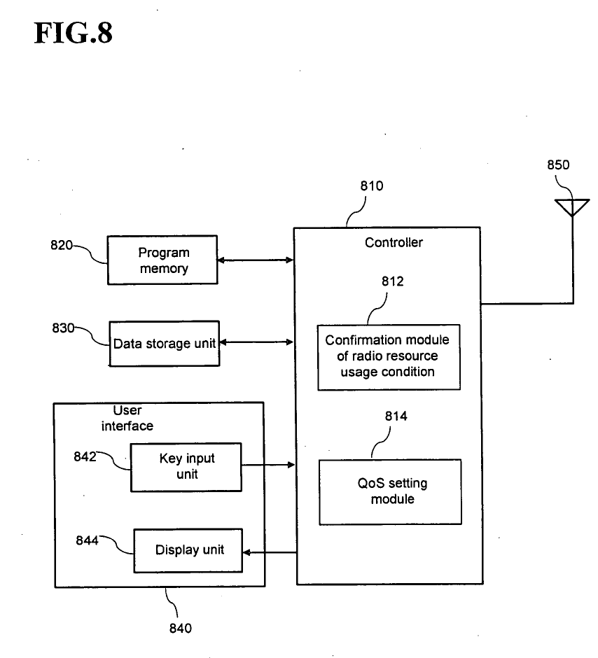

FIG. 8 is a diagram showing the terminal wherein the QoS setting is performed according to the exemplary embodiment of the present invention.

The terminal includes a controller 810, program memory 820, data storage unit 830, user interface 840, and antenna 850.

The controller 810 controls the terminal, and includes a confirmation module of radio resource usage condition 812 and a QoS setting module 814.

The confirmation module of radio resource usage condition 812 determines the usage condition for the radio resource received from the base station through the antenna 850. In addition, the confirmation module of radio resource usage condition 812 determines if the radio resource usage condition transits in the base station compared to the previous usage condition. When the transition occurs, the confirmation module of radio resource usage condition 812 rechecks the service grade profile or displays the transition results on a display unit 844 included in the user interface 840.

The QoS setting module 814 sets the QoS of the terminal according to the user request for the QoS, and the QoS setting module 814 changes the QoS parameters according to the service grade checked by the service grade profile such that the QoS for the data service is established.

The program memory 820 stores a control program performing overall controls for the terminal, an application program for data services and additional services, a QoS setting program according to the exemplary embodiment of the present invention, and a confirmation program for the condition for the radio resource usage.

The data storage unit 830 performs data buffer function, wherein the data buffer is created during performing various data and programs used for the data services and additional services in the terminal, and the storage unit 830 stores the service grade profile, and QoS parameters according to the service grade.

The user interface 840 displays operations of the terminal to users or receives various requests from the users. The user interface 840 includes key input unit 842 and the display unit 844.

The key input unit 842 includes various key buttons, such as volume control button, direction button, menu connection button, number buttons and is utilized by a user for terminal control, QoS change by using various key buttons.

The display unit 844 displays the terminal operations including power usage condition, receiving strength for propagation, dates, and time, and it also displays the change of the conditions for the radio resource usage.

The antenna 850 is used during communication with the base station, in order to receive various data, information for the condition for the radio resource usage from the base station and then to transmit the data service request signal created in the terminal.

Consequently, since the terminal having the structure described above can establish the QoS, and allocates radio resource in the communication network according to the QoS set by the users, speed and cost for the data service demanded by users can be selected.

In addition, since the communication network allocates the radio resource to the terminal according to the current condition for the radio resource usage and the types of services, connection and the QoS for the service demanded by user can be guaranteed and the terminal can be efficiently operated by improving the radio resource usage.

The above-described methods and apparatuses are not only realized by the embodiment of the present invention, but, on the contrary, are intended to be realized by a program for executing functions corresponding to the environment established by the embodiments of the present invention or a recording medium for recording the program.

While this invention has been described in connection with what is presently considered to be practical and preferred embodiments, it is to be understood that the invention is not limited to the disclosed embodiments, but, on the contrary, is intended to cover various modifications and equivalent arrangements included within the spirit and scope of the appended claims.

What is claimed is:

1. A method for setting quality of service (QoS) in a terminal comprising:
receiving from a base station first information regarding a radio resource usage condition in a communication network;
setting a current QoS according to the radio resource usage condition of the first information;
setting a path for a data service between the base station and the terminal;
receiving the data service by using the current QoS; and
receiving second information regarding the radio resource usage condition that is regularly provided by the base station; and
receiving the data service by resetting the current QoS according to the radio resource usage condition of the second information.

2. The method of claim 1, wherein the current QoS is set by determining at least one QoS established in a predetermined service grade profile.

3. The method of claim 2, wherein the at least one QoS established in the predetermined service grade profile is determined by using at least one of a network address of a server providing the data service, an application program executed by the data service, and the first information regarding the radio resource usage condition.

4. The method of claim 1, wherein the setting the current QoS comprises:
displaying the radio resource usage condition to a user; and
setting a QoS input from the user according to the radio resource usage condition as the current QoS.

5. The method of claim 1, wherein the first information regarding radio resource usage condition includes at least one of idle condition, resource enough condition, resource full condition, and resource overload condition which are classified by the residual amount of the radio resource in the base station.

6. The method of claim 1, wherein the receiving data service by resetting the current QoS comprises:
receiving from the base station the second information regarding the radio resource usage condition;
displaying the second information;
receiving from a user a request for resetting QoS;
setting the QoS requested for resetting as the current QoS; and
receiving the data service by using the current QoS.

7. The method of claim 6, wherein the second information is one of always displayed, displayed when the radio resource usage condition changes, and displayed when the user requests the second information.

8. The method of claim 1, wherein the receiving of the data service by resetting the current QoS comprises:
receiving from the base station the second information regarding the radio resource usage condition;
determining if the radio resource usage condition is changed;
determining the QoS on the changed radio resource usage condition by using the predetermined service grade profile when the radio resource usage condition is changed;
setting the determined QoS as the current QoS; and
receiving the data service by using the current QoS.

9. The method of claim 1, wherein the QoS is set by selecting a service grade from one of a guaranteed service (GS) grade for receiving a data service of high-priority data transmission including a real-time service, a controlled-load (CL) service grade for an ordinary data service of medium-priority data transmission, and a best effort (BS) service grade for receiving a data service of low-priority data transmission that is not closely related to time.

10. A terminal for selecting a quality of service (QoS) of a data service by determining a radio resource usage condition in a communication network, the terminal comprising:
a data storage unit for storing a service grade profile including information regarding a QoS set according to the radio resource usage condition;
a program memory for storing a program for controlling the terminal, an application program for the data service, a QoS setting program, and a program for determining the radio resource usage condition;
a user interface for providing the terminal user with the radio resource usage condition from the communication network or receiving from the terminal user requests for setting or changing the QoS; and
a controller for receiving the radio resource usage condition from the communication network to display the radio resource usage condition through the user interface, and controlling QoS setting operations by executing instruction for setting a QoS or for changing a QoS by using the QoS setting program.

11. The terminal of claim 10, wherein the controller comprises:
a radio resource usage condition checking module for determining the radio resource usage condition received from the communication network; and
a QoS setting module for setting the QoS according to the service grade profile and the instruction for setting a QoS or changing a QoS received through the user interface.

12. The terminal of claim 11, wherein the radio resource usage condition module checks the service grade profile or displays a current radio resource usage condition through the user interface when the current radio resource usage condition is different from the previous radio resource usage condition.

13. A recording medium for recording a program for executing a method for setting a quality of service (QoS) in a terminal, the method comprising:
receiving from a base station first information regarding a radio resource usage condition in a communication network;
setting a QoS according to the first information; and
receiving data service from the base station by using the QoS.

14. The recording medium of claim 13, wherein the setting of the QoS comprises displaying to the user the first information and setting the QoS input from the user according to the first information.

15. The recording medium of claim 13, wherein the QoS is set by determining a QoS established in a service grade profile.

16. The recording medium of claim 13, wherein the first radio resource usage condition includes at least one of an idle condition, resource enough condition, resource full condition, and resource overload condition, which are classified by the residual amount of the radio resource in the base station.

17. The recording medium of claim 13, wherein the method further comprises:
receiving from the base station second information regarding radio resource usage condition;
receiving a request for resetting the QoS according to the second information;
resetting the QoS; and
receiving a data service from the base station by using the reset QoS.
